(19) United States
(12) Patent Application Publication
(10) Pub. No.: US 2008/0163735 A1
(43) Pub. Date: Jul. 10, 2008

(54) Saw Blade for Wood

(76) Inventors: Ulf Lundin, Sveg (SE); Ronny Olofsson, Sveg (SE); Erik Eriksson, Bollnas (SE)

Correspondence Address: BUCHANAN, INGERSOLL & ROONEY PC, POST OFFICE BOX 1404, ALEXANDRIA, VA, 22313-1404, US

(21) Appl. No.: 10/592,232

(22) PCT Filed: Mar. 10, 2005
(86) PCT No.: PCT/SE2005/000347

§ 371 Date: Sep. 11, 2006

(30) Foreign Application Priority Data
Mar. 11, 2004 (SE) 0400607-8

(51) Int. Cl. B27B 33/02

(52) U.S. Cl. 83/848

(57) ABSTRACT

A saw blade for cutting of wood, comprising cutting teeth which have filed or sharpened front and rear lateral edges, said edges meeting at a sharp point alternately on the right and the left side of the saw blade, where the cutting teeth are arranged in recurrent main groups of eight cutting teeth, each main group being divided into two subgroups comprising four cutting teeth each. Each subgroup comprises one cutting tooth set to a first side, two cutting teeth set to a second side opposite said first side, and one unset cutting tooth located between the two last-mentioned cutting teeth, and the set cutting teeth in each subgroup are set respectively to that side where the sharp point is located.

### TECHNICAL FIELD

The present invention relates to a saw blade for cutting of wood, comprising cutting teeth which have filed or sharpened front and rear lateral edges, said edges meeting at a sharp point alternately on the right and the left side of the saw blade.

### BACKGROUND OF THE INVENTION

Saw blades for wood having ground or filed teeth, where each tooth by chamfering the front and rear lateral edges on the same side has a sharp point, the sharp points being located alternately on the right and the left side of the saw blade, and said teeth being set to that side where the sharp points are located. Said setting prevents the saw blade from jamming in the kerf or saw cut. Such saw blades are easy to maintain by resharpening with a file, are efficient for cross-cutting, at least of dry wood, and are operative in both directions of movement.

Since hardening of the tooth points of the saw blades has become more common, fewer demands on sharpening are made, and other setting patterns have been proposed. From DE 854 570, for example, it is known to produce saw blades for wood where all teeth have sharp points, but some teeth are set and serve to cut, and other teeth are not set and serve substantially to clear or scrape sawdust from the kerf. Also the scraping teeth have sharp points alternately on the right and the left side of the saw blade.

It is also known from DE 854 570 and U.S. Pat. No. 2,072,624 to arrange the teeth in recurrent groups comprising cutting and scraping teeth with different distances, which serves to minimize the vibration when sawing and produce smooth cut surfaces.

Saw blades with both cutting and scraping teeth have been shown to cut particularly fast and efficiently in moist wood. However, the above proposed setting patterns have proven to be difficult to produce, since they comprise teeth with different edge angles and different sizes. The consequence of this is also that saw blades having above proposed setting patterns are difficult to maintain. Further, the above proposed setting patterns do not provide sawing with a satisfactory low vibration and straight crosscutting.

The Swedish patent application 0100895-2 (SE 523 982, EP 1 240 965 A1) discloses a saw blade for cutting of wood, where all teeth have filed or sharpened front and rear lateral edges, said edges meeting at a sharp point alternately on the right and the left side of the saw blade, said teeth being arranged in recurrent groups of six teeth. Each group of six teeth is divided into two subgroups comprising three teeth each, the first tooth in the first subgroup being set to one side and the first tooth in the second subgroup being set to the opposite side. One of the teeth in each subgroup is unset, and the other two in each subgroup are set respectively to that side where the sharp point is located. The object of this saw blade is to provide sawing with a lower vibration and a straighter crosscutting. This saw blade is also said to be easier to produce.

Further, in experiments it has been shown that the amount of cutting teeth should be greater than the amount of scraping teeth.

### THE OBJECT OF THE INVENTION

The object of the present invention is to provide a saw blade which has teeth arranged according to such a setting pattern that the sawing by means of said saw blade becomes more efficient, and that the saw blade reduces vibrations in operation and provides a straighter crosscutting compared to prior art saw blades.

### SUMMARY OF THE INVENTION

The above mentioned object of the present invention is attained by providing a saw blade of the kind defined in the preamble of claim 1, which comprises the special features that the cutting teeth are arranged in recurrent main groups of eight cutting teeth, each main group being divided into two subgroups comprising four cutting teeth each, that each subgroup comprises one cutting tooth set to a first side, two cutting teeth set to a second side opposite said first side, and one unset cutting tooth located between the two last-mentioned cutting teeth, and that the set cutting teeth in each subgroup are set respectively to that side where the sharp point is located. The term “cutting tooth” refers to a tooth which has a cutting effect in the material to be cut. By this setting pattern side forces are out balanced when sawing, and a saw blade is attained which considerably reduces vibrations in operation and provides a significantly straighter crosscutting, which provides a more efficient cutting compared to prior art saw blades.

According to an advantageous embodiment of the saw blade according to the present invention, two cutting teeth in the first subgroup are set to one of said first and second sides, and two cutting teeth in the second subgroup are set to the opposite side.

According to a further advantageous embodiment of the saw blade according to the present invention, the fourth cutting tooth in the first subgroup is set to one of said first and second sides, and the first cutting tooth in the second subgroup is set to the opposite side.

According to another advantageous embodiment of the saw blade according to the present invention, the distances between the subgroups are larger than the distances between the cutting teeth within the subgroups.

According to yet another advantageous embodiment of the saw blade according to the present invention, at least one unset scraping tooth is arranged between the subgroups comprising four cutting teeth each and between the main groups comprising eight cutting teeth each. The term “scraping tooth” refers to a tooth which does not have a cutting effect but a scraping effect, so that sawdust is scraped from the kerf. For example, the scraping tooth can comprise two points angled away from each other, and advantageously, the sharp point of the cutting teeth extends above the height of the scraping tooth.

According to an advantageous embodiment of the saw blade according to the present invention, the distances between a scraping tooth and a subgroup are larger than the distances between the cutting teeth within the subgroups.

A saw blade according to the invention can be provided with a handle or form a part of a saw of fog saw type. It is especially advantageous to be used for a bow saw for cutting wood and is then designed with a band shape with a small width having teeth with the same inclination and sharp front and rear lateral edges, so that the blade can be turned round, or the sawing can be performed with both pull and push stroking motion.

### BRIEF DESCRIPTION OF THE DRAWINGS

The present invention will now be described, for exemplary purposes, in more detail by way of embodiments and with reference to the enclosed drawings, in which:

FIG. 1 is a schematic side view of an embodiment of the saw blade according to the present invention, seen from the side, and

FIG. 2 is a schematic top view of the same embodiment of the saw blade of FIG. 1, seen in the plane of the saw blade.

### DETAILED DESCRIPTION OF THE INVENTION

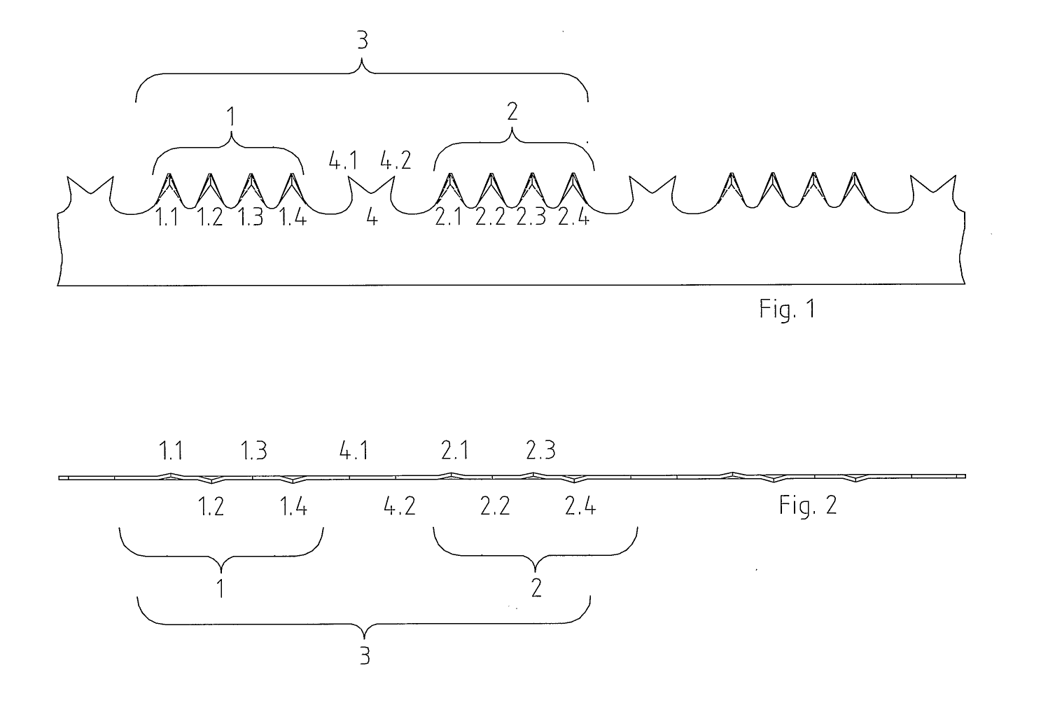

FIG. 1 shows a portion of an embodiment of the saw blade according to the present invention, seen from the left side of the saw blade. In FIG. 1, arranged cutting teeth 1.1, 1.2, 1.3, 1.4, 2.1, 2.2, 2.3, 2.4 are shown, which have filed or ground front and rear lateral edges, said edges meeting at a sharp point alternately on the right and the left side of the saw blade. The cutting teeth 1.1, 1.3, 2.1, and 2.3 meet at a sharp point on the right side of the blade, which in FIG. 1 is illustrated by dashed lines indicating the chamfered edges for respective sharp point, and the cutting teeth 1.2, 1.4, 2.2, and 2.4 meet at a sharp point on the left side of the blade, which in FIG. 1 is illustrated by continuous lines indicating the chamfered edges for respective sharp point. The cutting teeth 1.1, 1.2, 1.3, 1.4, 2.1, 2.2, 2.3, 2.4 of the saw blade are arranged in recurrent main groups 3 of eight cutting teeth 1.1, 1.2, 1.3, 1.4, 2.1, 2.2, 2.3, 2.4, each main group 3 being divided into a first subgroup 1 and a second subgroup 2 comprising four cutting teeth 1.1, 1.2, 1.3, 1.4, 2.1, 2.2, 2.3, 2.4 each. All cutting teeth 1.1, 1.2, 1.3, 1.4, 2.1, 2.2, 2.3, 2.4 are made though grinding or filing and have the same height. Between the subgroups 1, 2 and between the main groups 3 an unset scraping tooth 4 is arranged, comprising a first point 4.1 and a second point 4.2 which are angled away from each other. However, it is possible to arrange several scraping teeth at the same position. The sharp point of the cutting teeth 1.1, 1.2, 1.3, 1.4, 2.1, 2.2, 2.3, 2.4 extends above the height of the scraping tooth 4. As FIG. 4 shows, the distances between the subgroups 1, 2 are larger than the distances between the cutting teeth 1.1, 1.2, 1.3, 1.4, 2.1, 2.2, 2.3, 2.4 within the subgroups 1, 2, and the distances between a scraping tooth 4 and a subgroup 1, 2 are larger than the distances between the cutting teeth 1.1, 1.2, 1.3, 1.4, 2.1, 2.2, 2.3, 2.4 within the subgroups 1, 2.

FIG. 2 shows the same portion of the embodiment of the saw blade according to the present invention shown in FIG. 1, but seen in the plane of the saw blade. The first subgroup 1 comprises a first cutting tooth 1.1 set to the right side of the saw blade, a second cutting tooth 1.2 set to the left side of the saw blade, a third unset cutting tooth 1.3 and a fourth cutting tooth 1.4 set to the left side of the saw blade. The third unset cutting tooth 1.3 is thus arranged between the second and fourth cutting teeth 1.2, 1.4. The second subgroup 2 comprises, in turn, a first cutting tooth 2.1 set to the right side of the saw blade, a second unset cutting tooth 2.2, a third cutting tooth 2.3 set to the right side of the saw blade, and a fourth cutting tooth 2.4 set to the left side of the saw blade. The second unset cutting tooth 2.2 is thus arranged between the first and third cutting teeth 2.1, 2.3. The set cutting teeth 1.1, 1.2, 1.4, 2.1, 2.3, 2.4 in each subgroup 1, 2 are set respectively to that side where the sharp point is located. As FIG. 2 shows, the second and fourth cutting teeth 1.2, 1.4 of the first subgroup 1, between which an intermediate unset cutting tooth 1.3 is arranged, are set to the left side of the saw blade while the first and third cutting teeth 2.1, 2.3 of the second subgroup 2, between which an intermediate unset cutting tooth 2.2 is arranged, are set to the opposite side, i.e. the right side of the saw blade. Further, FIG. 2 shows that the fourth cutting tooth 1.4 of the first subgroup 1 is set to the left side of the saw blade while the first cutting tooth 2.1 of the second subgroup 2 is set to the opposite side, i.e. the right side of the saw blade. Naturally, the setting pattern here described in detail is not restricted to the left and right side, respectively, of the saw blade but can also be a mirror image of said setting pattern and still achieve the same effect.

1-8. (canceled)

9. A saw blade for cutting of wood, comprising cutting teeth which have filed or sharpened front and rear lateral edges, said edges meeting at a sharp point alternately on the right and the left side of the saw blade, wherein the cutting teeth are arranged in recurrent main groups of eight cutting teeth, each main group being divided into two subgroups comprising four cutting teeth each, that each subgroup comprises one cutting tooth set to a first side, two cutting teeth set to a second side opposite said first side, and one unset cutting tooth located between the two last-mentioned cutting teeth, and that the set cutting teeth in each subgroup are set respectively to that side where the sharp point is located.

10. A saw blade according to claim 9 wherein the distances between the adjacent subgroups are larger than the distances between the cutting teeth within the subgroups.

11. A saw blade according to claim 10, wherein the fourth cutting tooth in the first subgroup is set to one of said first and second sides, and the first cutting tooth in the second subgroup of the same main group is set to the opposite side.

12. A saw blade according to claim 10 wherein at least one unset scraping tooth is arranged between two adjacent subgroups and between two adjacent main groups.

13. A saw blade according to claim 9, wherein at least one unset scraping tooth is arranged between two adjacent subgroups and between two adjacent main groups.

14. A saw blade according to claim 13, wherein the scraping tooth comprises two points angled away from each other.

15. A saw blade according to claim 14, wherein the sharp points of the cutting teeth extend above the heights of the scraping teeth.

16. A saw blade according to claim 15, wherein the respective distances between a scraping tooth and each adjacent subgroup are larger than the distances between the cutting teeth within the subgroups.

17. A saw blade according to claim 13, wherein the sharp points of the cutting teeth extend above the heights of the scraping teeth.

18. A saw blade according to claim 17, wherein the respective distances between a scraping tooth and each adjacent subgroup are larger than the distances between the cutting teeth within the subgroups.

19. A saw blade according to claim 14, wherein the respective distances between a scraping tooth and each adjacent subgroup are larger than the distances between the cutting teeth within the subgroups.

20. A saw blade according to claim 9 wherein two cutting teeth in the first subgroup are set to one of said first and second sides, and two cutting teeth in the second subgroup of the same main group are set to the opposite side.

21. A saw blade according to claim 20 wherein the distances between adjacent subgroups are larger than the distances between the cutting teeth within the subgroups.

22. A saw blade according to claim 21 wherein at least one unset scraping tooth is arranged between two adjacent subgroups and between two adjacent main groups.

23. A saw blade according to claim 20 wherein at least one unset scraping tooth is arranged between two adjacent subgroups and between two adjacent main groups.

24. A saw blade according to claim 23 wherein the scraping tooth comprises two points angled away from each other.

25. A saw blade according to claim 23 wherein the sharp points of the cutting teeth extend above the heights of the scraping teeth.

26. A saw blade according to claim 9, wherein the fourth cutting tooth in the first subgroup is set to one of said first and second sides, and the first cutting tooth in the second subgroup of the same main group is set to the opposite side.

27. A saw blade according to claim 26, wherein at least one unset scraping tooth is arranged between two adjacent subgroups and between two adjacent main groups.

28. A saw blade according to claim 27 wherein the scraping tooth comprises two points angled away from each other.

29. A saw blade according to claim 27 wherein the sharp points of the cutting teeth extend above the heights of the scraping teeth.

30. A saw blade according to claim 26, wherein at least one unset scraping tooth is arranged between two adjacent subgroups and between two adjacent main groups.

31. A saw blade according to claim 30 wherein the sharp points of the cutting teeth extend above the heights of the scraping teeth.
